(19) United States
(12) Patent Application Publication
(10) Pub. No.: US 2008/0186803 A1
(43) Pub. Date: Aug. 7, 2008

(54) Fluid filled sensor mount for gel-filled streamer and streamer made therewith

(76) Inventors: Troy L. McKey, LaPlace, LA (US); Andre Stenzel, Richmond, TX (US)

Correspondence Address: E. Eugene Thigpen;Petroleum Geo-Services, Inc., P.O. Box 42805, Houston, TX, 77242-2805, US

(21) Appl. No.: 11/702,382

(22) Filed: Feb. 5, 2007

(51) Int. Cl. G01V 1/38

(52) U.S. Cl. 367/15

(57) ABSTRACT

A seismic streamer includes a jacket covering an exterior of the streamer. At least one strength member extends along the length of the jacket inside the jacket. At least one seismic sensor is disposed inside the jacket. The seismic sensor is disposed in a mount. The mount defines a sealed, liquid filled chamber inside the jacket. A material fills the void spaces inside the jacket and outside the chamber. The material is introduced to the void spaces in liquid form and cures to a gel thereafter.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic survey apparatus and methods. More specifically, the invention relates to structures for marine seismic streamers that have reduced noise induced by effects of towing such streamers in the water.

2. Background Art

In marine seismic surveying, a seismic vessel travels on the surface of a body of water such as a lake or the ocean. The seismic vessel typically contains seismic data acquisition equipment, which includes devices such as navigation control, seismic source control, seismic sensor control, and signal recording devices. The seismic acquisition equipment causes a seismic source towed in the body of water, by the seismic vessel or another vessel, to actuate at selected times. The seismic source may be any type well known in the art of seismic acquisition, including air guns or water guns, or most commonly, arrays of air guns. Seismic streamers, also called seismic cables, are elongate cable-like structures that are towed in the body of water by the seismic survey vessel or by another vessel. Typically, a plurality of seismic streamers is towed behind the seismic vessel laterally spaced apart from each other. The seismic streamers contain sensors to detect the seismic wavefields initiated by the seismic source and reflected from acoustic impedance boundaries in the subsurface Earth formations below the water bottom.

Conventionally, seismic streamers contain pressure-responsive sensors such as hydrophones, but seismic streamers have also been proposed that contain particle motion sensors, such as geophones, in addition to hydrophones. The sensors are typically located at selected intervals along the length of seismic streamers.

Seismic streamers also include electronic components, electrical wiring and may include other types of sensors. Seismic streamers are typically assembled from sections, each section being approximately 75 meters in length. A number of such sections are joined end to end, and can extend the assembled streamer to a total length of many thousands of meters. Position control devices, such as depth controllers, paravanes, and tail buoys are affixed to the streamer at selected positions and are used to regulate and monitor the movement of the streamer in the water. During operation, the seismic sources and streamers are typically submerged at a selected depth in the water. The seismic sources are typically operated at a depth of 5-15 meters below the water surface and the seismic streamers are typically operated at a depth of 5-40 meters.

A typical streamer section consists of an external jacket, connectors, spacers, and strength members. The external jacket is formed from a flexible, acoustically transparent material such as polyurethane and protects the interior of the streamer section from water intrusion. The connectors are disposed at the ends of each streamer section and link the section mechanically, electrically and/or optically to adjacent streamer sections and, therefore, ultimately link it to the seismic towing vessel. There is at least one, and are usually two or more such strength members in each streamer section that extend the length of each streamer section from one end connector to the other. The strength members provide the streamer section with the capability to carry axial mechanical load. A wire bundle or cable also extends the length of each streamer section, and can contain electrical power conductors and electrical data communication wires. In some instances, optical fibers for signal communication are included in the wire bundle.

Typically, hydrophones or groups of hydrophones are located within the streamer section. The hydrophones are frequently mounted within corresponding spacers for protection. The distance between hydrophone containing spacers is ordinarily about 0.7 meters. A hydrophone group, typically comprising 16 hydrophones, thus extends for a length of about 12.5 meters. The hydrophones in a group are typically connected in series to cancel effects of certain types of noise to which the streamer may be exposed. The interior of the seismic streamers is typically filled with a void filling material to provide buoyancy and desired acoustic properties. Many seismic streamers have been filled with a liquid, such as oil or kerosene.

Ideally, in a streamer moving at constant speed, all the streamer components including the jacket, the connectors, the spacers, the strength members, wire bundle, sensors and liquid void filling material all move at the same constant speed and do not move relative to each other. Under actual movement conditions, however, transient motion of the streamers takes place, such transient motion being caused by events such as pitching and heaving of the seismic vessel, movement of the paravanes and tail buoys attached to the streamers, strumming of the towing cables attached to the streamers caused by vortex shedding on the cables, and operation of depth-control devices located on the streamers. Any of the foregoing types of transient motion can cause transient motion (stretching) of the strength members. Transient motion of the strength members displaces the spacers or connectors, causing pressure fluctuations in the liquid void filling material that are detected by the hydrophones. Pressure fluctuations radiating away from the spacers or connectors also cause the flexible outer jacket to compress in and bulge out in the form of a traveling wave, giving the phenomenon “bulge waves” its name.

In addition, there are other types of noise, often called “flow noise”, which can affect the quality of the seismic signal detected by the hydrophones. For example, vibrations of the seismic streamer can cause extensional waves in the outer jacket and resonance transients traveling down the strength members. A turbulent boundary layer created around the outer jacket of the streamer by the act of towing the streamer can also cause pressure fluctuations in the liquid core-filling material. In liquid filled streamer sections, the extensional waves, resonance transients, and turbulence-induced noise are typically much smaller in amplitude than the bulge waves, however they do exist and affect the quality of the seismic signals detected by the hydrophones. Bulge waves are usually the largest source of vibration noise because these waves travel in the liquid core material filling the streamer sections and thus act directly on the hydrophones.

It is known in the art to replace the liquid core material in a streamer section with a soft, flexible solid core material, such as gel. The introduction of a softer, flexible solid material may block the development of bulge waves compared to a liquid core material. Using a soft, flexible material will eliminate a substantial portion of the problem with “bulge waves”, but the so-called Poisson effect from the strength members can increase. Because of the relatively high tensile stiffness of the strength members, transients generally travel along the strength members at velocities near to or greater than that of the sound velocity in water, such velocities typically in the range of 1000 to 1500 meters per second. The actual velocity of transients along the strength members depends mainly on the elastic modulus of the strength member material and the tension applied to the streamer as it is towed in the water. The lower the elastic modulus the more compliant the streamer will be, and thus the more transient energy it will dissipate as heat and the less will pass through the strength member. Special elastic sections are normally placed at either end of a streamer cable to reduce the effects of transients.

There is still a need to further improve the attenuation of longitudinal waves transmitted through the strength members of marine seismic streamers.

### SUMMARY OF THE INVENTION

One aspect of the invention is a seismic streamer. A seismic streamer according to this aspect of the invention includes a jacket covering an exterior of the streamer. At least one strength member extends along the length of the jacket inside the jacket. At least one seismic sensor is disposed inside the jacket. The seismic sensor is disposed in a mount. The mount defines a sealed, liquid filled chamber inside the jacket. A material fills the void spaces inside the jacket and outside the chamber. The material is introduced to the void spaces in liquid form and cures to a gel thereafter.

A sensor assembly for a marine seismic streamer according to another aspect of the invention includes two longitudinally spaced apart end plugs. Each end plug defines a first diameter portion and a second diameter portion. The first diameter portion is larger in diameter than the second diameter portion. A substantially acoustically transparent tube extends between the end plugs and is disposed outside the second diameter portion of each end plug. The tube and the end plugs define a sealed interior. A seismic sensor is disposed inside the tube, and liquid fills the interior.

Other aspects and advantages of the invention will be apparent from the description and claims which follow.

### BRIEF DESCRIPTION OF THE DRAWINGS

FIG. 1 shows typical marine seismic data acquisition using a streamer according to one embodiment of the invention.

FIG. 2 shows a cut away view of one embodiment of a streamer segment according to the invention.

FIG. 3 shows one example of a sensor mount.

FIG. 4 shows an end view of an end plug of the sensor mount of FIG. 3.

FIG. 5 shows a cross section of the end plug of FIG. 4.

FIG. 6 shows a seismic sensor disposed in a foam sleeve.

### DETAILED DESCRIPTION

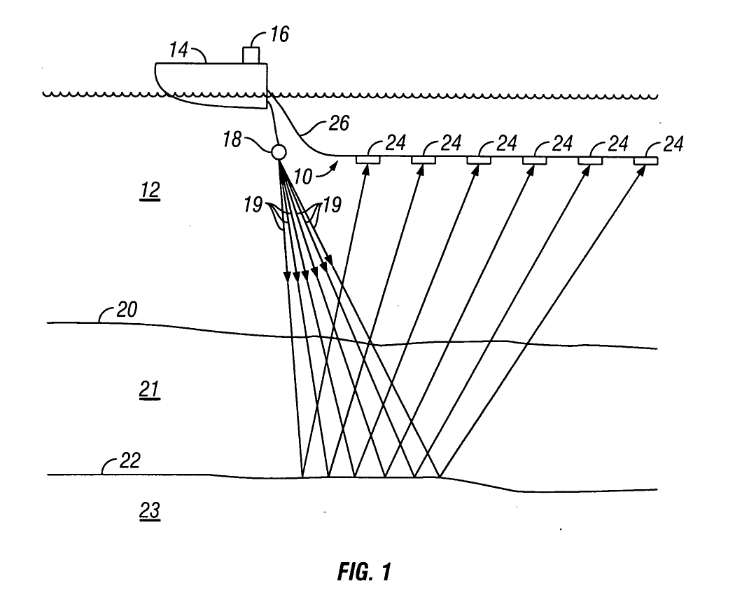

FIG. 1 shows an example marine seismic data acquisition system as it is typically used in acquiring seismic data. A seismic vessel 14 moves along the surface of a body of water 12 such as a lake or the ocean. The marine seismic survey is intended to detect and record seismic signals related to structure and composition of various subsurface formations 21, 23 below the water bottom 20. The seismic vessel 14 includes source actuation, data recording and navigation equipment, shown generally at 16, referred to for convenience as a “recording system.” The seismic vessel 14, or a different vessel (not shown), can tow one or more seismic energy sources 18, or arrays of such sources in the water 12. The seismic vessel 14 or a different vessel tows at least one seismic streamer 10 near the surface of the water 12. The streamer 10 is coupled to the vessel 14 by a lead in cable 26. A plurality of sensors, or arrays of such sensors, shown generally at 24, are disposed at spaced apart locations along the streamer 10. The sensors 24, as will be explained in more detail below, are formed by mounting a seismic sensor inside a particularly configured sensor mount, and disposing the sensor mounts having sensors therein along the streamer in a particular arrangement.

During operation, certain equipment (not shown separately) in the recording system 16 causes the source 18 to actuate at selected times. When actuated, the source 18 produces seismic energy 19 that emanates generally outwardly from the source 18. The energy 19 travels downwardly, through the water 12, and passes, at least in part, through the water bottom 20 into the formations 21, 23 below. Seismic energy 19 is at least partially reflected from one or more acoustic impedance boundaries 22 below the water bottom 20, and travels upwardly whereupon it may be detected by the sensors 24. Structure of the formations 21, 23, among other properties of the Earth's subsurface, can be inferred by travel time of the energy 19 and by characteristics of the detected energy such as its amplitude and phase.

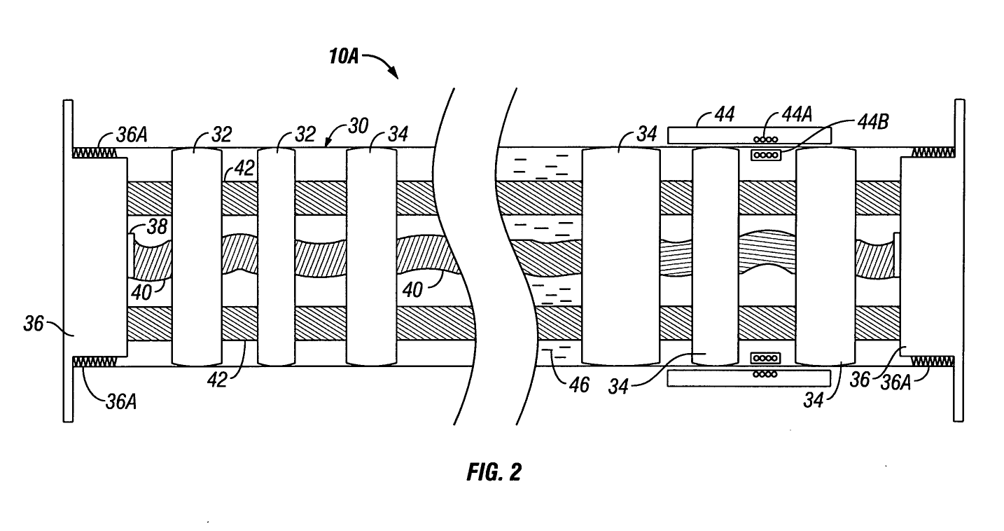

Having explained the general method of operation of a marine seismic streamer, an example embodiment of a streamer section according to the invention will be explained with reference to FIG. 2. FIG. 2 is a cut away view of a portion (segment) 10A of a typical marine seismic streamer (10 in FIG. 1). A streamer as shown in FIG. 1 may extend behind the seismic vessel (14 in FIG. 1) for several kilometers, and is typically made from a plurality of streamer segments 10A as shown in FIG. 2 connected end to end behind the vessel (14 in FIG. 1).

The streamer segment 10A in the present embodiment may be about 75 meters overall length. A streamer such as shown at 10 in FIG. 1 thus may be formed by connecting a selected number of such segments 10A end to end. The segment 10A includes a jacket 30, which in the present embodiment can be made from 3.5 mm thick transparent polyurethane and has a nominal external diameter of about 62 millimeters. In each segment 10A, each axial end of the jacket 30 may be terminated by a coupling/termination plate 36. The coupling/termination plate 36 may include rib elements 36A on an external surface of the coupling/termination plate 36. Such surface is inserted into the end of the jacket 30, so as to seal against the inner surface of the jacket 30 and to grip the coupling/termination plate 36 to the jacket 30 when the jacket 30 is secured by an external clamp (not shown). In the present embodiment, two strength members 42 can be coupled to the interior of each coupling/termination plate 36 and can extend the length of the segment 10A. In a particular implementation of the invention, the strength members 42 may be made from a fiber rope made from a fiber sold under the trademark VECTRAN, which is a registered trademark of Hoechst Celanese Corp., New York, N.Y. The strength members 42 transmit axial load along the length of the segment 10A. When one segment 10A is coupled end to end to another such segment (not shown in FIG. 2), the mating coupling/termination plates 36 are coupled together using any suitable connector, so that the axial force is transmitted through the coupling/termination plates 36 from the strength members 42 in one segment 10A to the strength member in the adjoining segment.

The segment 10A can include a number of buoyancy spacers 34 disposed in the jacket 30 and coupled to the strength members 42 at spaced apart locations along their length. The buoyancy spacers 34 may be made from foamed polyurethane or other suitable, selected density material. The buoyancy spacers 34 have a density selected to provide the segment 10A preferably with approximately the same overall density as the water (12 in FIG. 1), so that the streamer (10 in FIG. 1) will be substantially neutrally buoyant in the water (12 in FIG. 1). As a practical matter, the buoyancy spacers 34 provide the segment 10A with an overall density very slightly less than that of fresh water. Appropriate overall density may then be adjusted in actual use by adding selected buoyancy spacers 34 and fill media having suitable specific gravity.

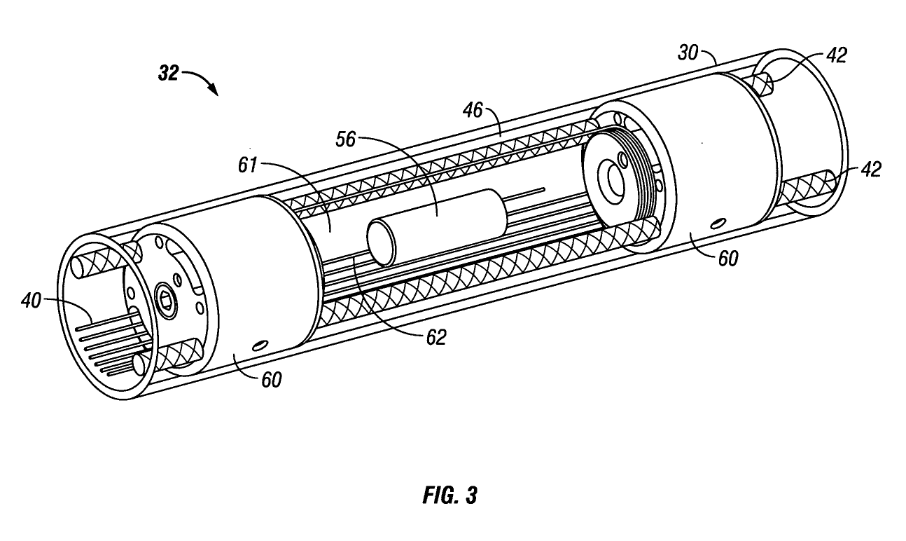

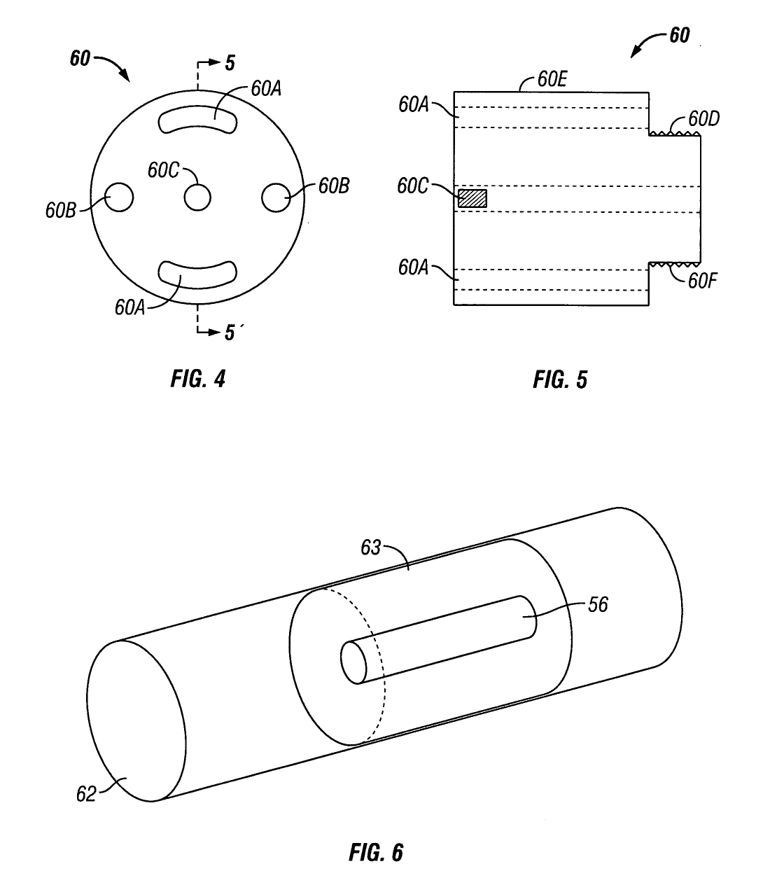

The segment 10A includes a generally centrally located conductor cable 40 which can include a plurality of insulated electrical conductors (not shown separately), and may include one or more optical fibers (not shown). The cable 40 conducts electrical and/or optical signals from the sensors (which will be further explained below with reference to FIGS. 3 and 4) to the recording system (16 in FIG. 1). The cable 40 may in some implementations also carry electrical power to various signal processing circuits (not shown separately) disposed in one or more segments 10A, or disposed elsewhere along the streamer (10 in FIG. 1). The length of the conductor cable 40 within a cable segment 10A is generally longer than the axial length of the segment 10A under the largest expected axial stress on the segment 10A, so that the electrical conductors and optical fibers in the cable 40 will not experience any substantial axial stress when the streamer 10 is towed through the water by a vessel. The conductors and optical fibers in the cable 40 may be terminated in a connector 38 disposed in each coupling/termination plate 36 so that when the segments 10A are connected end to end, corresponding electrical and/or optical connections may be made between the electrical conductors and optical fibers in the conductor cable 40 in adjoining segments 10A.

Sensors, which in the present embodiment may be hydrophones, can each be disposed inside a sensor mount, shown in FIG. 2 generally at 32. The hydrophones in the present embodiment can be of any type known to those of ordinary skill in the art, including but not limited to those sold under model number T-2BX by Teledyne Geophysical Instruments, Houston, Tex.

In the present embodiment, and as will be explained below with reference to FIG. 5, each segment 10A may include 96 such hydrophones, disposed in arrays. Each such array may include sixteen individual hydrophones connected in electrical series (or optical series if the sensors are optical sensors). In a particular implementation of the invention, there are thus six such arrays, spaced apart from each other at about 12.5 meters. The spacing between individual hydrophones in each array should be selected so that the axial span of the array is at most equal to about one half the wavelength of the highest frequency seismic energy intended to be detected by the streamer (10 in FIG. 1). It should be clearly understood that the types of sensors used, the electrical and/or optical connections used, the number of such sensors, and the spacing between such sensors are only used to illustrate one particular embodiment of the invention, and are not intended to limit the scope of this invention. In other embodiments, the sensors may be particle motion sensors such as geophones or accelerometers. A marine seismic streamer having particle motion sensors is described in U.S. patent application Ser. No. 10/233,266, filed on Aug. 30, 2002, entitled, Apparatus and Method for Multicomponent Marine Geophysical Data Gathering, assigned to an affiliated company of the assignee of the present invention and incorporated herein by reference. The sensors may also be optical sensors.

At selected positions along the streamer (10 in FIG. 1) a compass bird 44 may be affixed to the outer surface of the jacket 30. The compass bird 44 includes a directional sensor (not shown separately) for determining the geographic orientation of the segment 10A at the location of the compass bird 44. The compass bird 44 may include an electromagnetic signal transducer 44A for communicating signals to a corresponding transducer 44B inside the jacket 30 for communication along the conductor cable 40 to the recording system (16 in FIG. 1). Measurements of direction are used, as is known in the art, to infer the position of the various sensors in the segment 10A, and thus along the entire length of the streamer (10 in FIG. 1). Typically, a compass bird will be affixed to the streamer (10 in FIG. 1) about every 300 meters (every four segments 10A). One type of compass bird is described in U.S. Pat. No. 4,481,611 issued to Burrage and incorporated herein by reference.

In the present embodiment, the interior space of the jacket 30 may be filled with a material 46 such as buoyancy void filler (“BVF”), which may be a curable, synthetic urethane-based polymer. The BVF 46 serves to exclude fluid (water) from the interior of the jacket 30, to electrically insulate the various components inside the jacket 30, to add buoyancy to a streamer section and to transmit seismic energy freely through the jacket 30 to the sensors (in sensor mounts 32). The BVF 46 in its uncured state is essentially in liquid form. Upon cure, the BVF 46 no longer flows as a liquid, but instead becomes substantially solid. However, the BVF 46 upon cure retains some flexibility to bending stress, substantial elasticity, and freely transmits seismic energy to the sensors (in sensor mounts 32). It should be understood that the BVF used in the present embodiment is only one example of a gel-like substance that can be used to fill the interior of the streamer. Other materials could be also used. For example, heating a selected substance, such as a thermoplastic, above its melting point, and introducing the melted plastic into the interior of the jacket 30, and subsequent cooling, may also be used in a streamer according to the invention. Oil or similar material may also be used to fill the interior of the streamer.

Referring to FIG. 3, one embodiment of a sensor mount 32 having a seismic sensor 56 therein will be explained. The sensor mount 32 is shown in oblique view in FIG. 3 to illustrate some of the features. The sensor mount 32 includes an end plug 60 disposed at each longitudinal end of the sensor mount 32. The end plugs 60 have a “full diameter” portion, to be explained in more detail with reference to FIGS. 4 and 5, that has an outer diameter substantially the same as the inside diameter of the jacket 30 and thus fits snugly inside the jacket 30. The end plugs 60 also each have a “reduced diameter” portion, also explained with reference to FIGS. 4 and 5, that is smaller in diameter than the full diameter portion. The reduced diameter portion provides a landing for a flexible tube 62 that extends longitudinally between the end plugs 60. The flexible tube 62 may be made from the same material as the jacket 30, or may be made from a different material. The flexible tube 62 material should be substantially transparent to acoustic energy entering radially from outside the tube 62, and should have sufficient tensile strength to support at least part of the axial loading applied during assembly of the streamer components into the jacket 30.

The end plugs 60 also include passages (FIGS. 4 and 5) for the cable 40 and for the strength members 42. As will be shown in FIGS. 4 and 5, the passages are configured such that the cable (40 in FIG. 2) and the strength members 42 are disposed outside the tube 62 but inside the jacket 30 as they pass between the end plugs 60 of each sensor mount 32. The inside of the flexible tube 62 is typically filled with liquid such as oil or kerosene. The tube 62 cooperatively engages the smaller diameter portions of the end plugs 60, to be explained below with reference to FIG. 5, so as to define a substantially sealed interior 61 located generally inside the tube 62. A seismic sensor 56 such as a hydrophone, is shown generally centrally positioned in the substantially sealed interior 61. As will be explained with reference to FIG. 6, one device for positioning the sensor 56 in the center of the tube 62 is an open cell foam sleeve.

FIG. 4 shows an end view of one of the end plugs 60. As explained above, the end plug 60 may be molded from dense, rigid plastic such as polypropylene. Passages 60A are disposed near the lateral edge of each end plug 60 to provide a through passage for the cable (40 in FIG. 2) and any ancillary devices requiring passage through the sensor mount (32 in FIG. 3). As explained above, any device passing through the passages 60A between the two end plugs 60 will be disposed outside the tube (62 in FIG. 3) and inside the jacket (30 in FIG. 3).

The passages 60A also provide an opening for fluid to move freely in the annular space between the interior of the jacket (30 in FIG. 3) and the exterior of the tube (62 in FIG. 3). During assembly of the streamer, the BVF (46 in FIG. 2) in liquid form is introduced to the interior of the jacket (30 in FIG. 3). The liquid phase BVF is thus able to fill the annular space between the jacket (30 in FIG. 3) and the tube (62 in FIG. 3), along with the other void spaces in the interior of the jacket (30 in FIG. 3), and thus surrounds the exterior of the flexible tube (62 in FIG. 3).

Other passages 60B in the end plugs 60 may be provided for the strength member (42 in FIG. 2). Typically such passages 42 are shaped and sized so that the strength members (42 in FIG. 3) may be adhesively or otherwise bonded to the end plugs 60. The end plug 60 may also include a filler plug 60C that may be, for example, threadedly retained in a suitable opening (FIG. 5) in the center portion of the end plug 60. Such opening and filler plug 60C are provided to enable filling the interior (61 in FIG. 3) of the tube (62 in FIG. 3) with liquid, such as kerosene or oil as explained above. The liquid is preferably electrically non conductive and will not induce corrosion in any metallic elements disposed in the interior (61 in FIG. 3).

A cross sectional view of one of the end plugs 60 is shown in FIG. 5. FIG. 5 shows the arrangement of the filler plug 60C in its respective opening in the end plug 60. FIG. 5 also shows the full diameter portion 60E, which has a diameter selected to fit snugly inside the jacket (30 in FIG. 3) as explained above. FIG. 5 also shows the reduced diameter portion 60D onto which one end of the tube (62 in FIG. 3) may be affixed. The outer surface of the reduced diameter portion 60D may include gripping elements 60E to assist sealing the tube (62 in FIG. 3) to the end plug 60 and to assist retaining the tube (62 in FIG. 3) onto the end plug 60.

FIG. 6 shows one example of mounting the seismic sensor 56 inside the tube 62. The sensor 56 may be surrounded by a sensor holder 63 such as open cell foam sleeve 63. The sensor holder 63 may have an external diameter such that it fits snugly inside the flexible tube 62. The sensor holder 63 holds the sensor 56 in position, preferably in the radial center of the tube 62. It is believed that performance of the sensor 56 may be improved by retaining the sensor 56 in the radial center of the sensor spacer. Open cell foam may be used for the sensor holder 63 to enable free passage of pressure waves in the liquid filling the tube 62 to the sensor 56. Thus, seismic energy imparted to the exterior of the jacket (30 in FIG. 3) will be freely transmitted through the jacket, through the BVF (46 in FIG. 2), through the tube 62 to the sensor 56. Alternatively, the sensor 56 may be retained in position inside the tube 62 using elastomer rings or similar device.

A streamer made using sensors disposed in sensor mounts made as described herein may provide substantially reduced effect of longitudinally traveling “v-waves” than streamers made according to structures known in the art prior to the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic streamer, comprising:
a jacket covering an exterior of the streamer;
at least one strength member extending along the length of the jacket, the strength member disposed inside the jacket;
at least one seismic sensor disposed inside the jacket, the at least one seismic sensor disposed in a mount, the mount defining a sealed, liquid filled chamber inside the jacket; and
a material filling the void spaces inside the jacket and outside the chamber, the material introduced to the void spaces in liquid form and curing to a gel thereafter.

2. The streamer of claim 1 wherein the mount includes two longitudinally spaced apart end plugs and a tube disposed longitudinally between the end plugs.

3. The streamer of claim 2 wherein the end plugs each include at least one through passage, the through passage disposed radially externally to the tube such that a device passed through the passage and longitudinally between the end plugs is disposed externally to the tube and internally to the jacket.

4. The streamer of claim 2 wherein the end plugs each define a first diameter portion having an outer diameter substantially the same as an internal diameter of the jacket, and second diameter portion having an outer diameter smaller than the first diameter portion and substantially the same as an inner diameter of the tube.

5. The streamer of claim 4 wherein an external diameter of the tube is selected to provide an annular space between an exterior surface thereof and an interior surface of the jacket.

6. The streamer of claim 2 further comprising a sensor holder disposed inside the tube, the sensor holder arranged to retain the sensor substantially in the radial center of the tube.

7. The streamer of claim 6 wherein the sensor holder comprises open cell foam.

8. The streamer of claim 2 further comprising an open cell foam sensor holder disposed inside the tube and surrounding the sensor.

9. A seismic streamer, comprising:
a jacket covering an exterior of the streamer;
at least one strength member extending along the length of the jacket, the strength member disposed inside the jacket;
a plurality of seismic sensors disposed at spaced apart positions inside the jacket, each seismic sensor disposed in a mount, each mount defining a sealed, liquid filled chamber inside the jacket; and
a material filling the void spaces inside the jacket and outside the chamber, the material introduced to the void spaces in liquid form and curing to a gel thereafter.

10. The streamer of claim 9 wherein each mount includes two longitudinally spaced apart end plugs and a tube disposed longitudinally between the end plugs.

11. The streamer of claim 10 wherein the end plugs define a first diameter portion having an outer diameter substantially the same as an internal diameter of the jacket, and second diameter portion having an outer diameter smaller than the first diameter portion and substantially the same as an inner diameter of the tube.

12. The streamer of claim 11 wherein an external diameter of the tube is selected to provide an annular space between an exterior surface thereof and an interior surface of the jacket.

13. The streamer of claim 10 wherein the end plugs each include at least one through passage, the through passage disposed radially externally to the tube such that a device passed through the passage is disposed externally to the tube and internally to the jacket.

14. The streamer of claim 10 further comprising a sensor holder disposed inside each tube, each sensor holder arranged to retain the corresponding sensor substantially in the radial center of the tube.

15. The streamer of claim 14 wherein each sensor holder comprises open cell foam.

16. The streamer of claim 10 further comprising an open cell foam sensor holder disposed inside each tube and surrounding each sensor.

17. A sensor assembly for a marine seismic streamer, comprising:
two longitudinally spaced end plugs, each plug defining a first diameter portion and a second diameter portion, the first diameter portion larger in diameter than the second diameter portion;
a substantially acoustically transparent tube extending between the end plugs and disposed outside the second diameter portion of each end plug, the tube and end plugs defining a sealed interior;
a seismic sensor disposed inside the tube; and
liquid filling the interior.

18. The sensor assembly of claim 17 wherein the sensor comprises a hydrophone.

19. The sensor assembly of claim 18 wherein the sensor is disposed in the interior in an open cell foam sleeve.

20. The sensor assembly of claim 18 wherein the tube is formed from polyurethane.

21. The sensor assembly of claim 17 wherein each end plug defines at least one passage therethrough in a lateral position such that an object passed through the passage is disposed externally to the tube.

22. The sensor assembly of claim 17 wherein the first diameter portion is selected to provide interference fit within a jacket of s seismic streamer.

23. The sensor assembly of claim 17 further comprising a sensor holder disposed inside the tube, the sensor holder arranged to retain the sensor substantially in the radial center of the tube.

24. The sensor assembly claim 23 wherein the sensor holder comprises open cell foam.

25. The sensor assembly of claim 17 further comprising an open cell foam sensor holder disposed inside the tube and surrounding the sensor.

26. The sensor assembly of claim 17 wherein the liquid comprises at least one of oil and kerosene.

27. The sensor assembly of claim 17 wherein the end plugs are formed from polypropylene.

28. The sensor assembly of claim 17 wherein at least one of the end plugs comprises a filler plug and a passage therefor, the filler plug removable to enable filling the interior with the liquid.
